(19) United States
(12) Patent Application Publication
(10) Pub. No.: US 2002/0069352 A1
(43) Pub. Date: Jun. 6, 2002

(54) System and method for efficient BIOS initialization

(76) Inventor: Blaise B. Fanning, El Dorado Hills, CA (US)

Correspondence Address: Gregory D. Caldwell, BLAKELY, SOKOLOFF, TAYLOR & ZAFMAN, LLP, 7th Floor, 12400 Wilshire Boulevard, Los Angeles, CA, 90025, US

(21) Appl. No.: 09/728,035

(22) Filed: Dec. 1, 2000

(51) Int. Cl. G06F 9/00

(52) U.S. Cl. 713/1; 713/100

(57) ABSTRACT

A method and system for storing a set of data representing a memory configuration in a first memory. The set of data represents a first memory configuration of a second memory. The set of data is transmitted from the first memory to the second memory if the first memory configuration has changed.

The present invention relates to basic input and output system (BIOS) and specifically to a system, software, and method for reducing BIOS configuration time by storing configuration data in non-volatile memory.

### DESCRIPTION OF THE RELATED ART

Computer systems typically include hardware-dependent software that must be valid when electrical power is applied to the systems. The software includes instructions that initialize system hardware components and provide a basic input and output system (BIOS). The BIOS provides an interface between system software and hardware such as a core logic chip set, a graphics controller, and a memory. Computer system software programs typically access system hardware components using the BIOS.

Computer systems utilize various types of memory devices. Typically, computer systems utilize static random access memory (SRAM) as a high-speed memory. However, for larger memory requirements computer systems utilize dynamic random access memory (DRAM) because of the cost savings. Also, Rambus™ DRAM (RDRAM) is one type of DRAM device. The RDRAM device offers faster memory access speeds than conventional DRAM devices such as fast page mode (FPM) and extended data out (EDO).

During a system boot, an initialization, or return from a low-power state, the BIOS analyzes the system configuration. For example, the BIOS performs a memory re-levelization process. The re-levelization process calculates the channel delay between the memory devices and the memory controller. The first step is the BIOS determines a time domain for each memory device in the system. The time domain is calculated by an iterative procedure of the processor sending transactions through the chipset memory controller to the memory device. Typically, there are five possible time domains that represent five different channel delays or electrical distances from the memory controller's pins. The second step is the BIOS programs the memory devices to delay returning the data to the chipset to correspond to the memory device's respective time domain.

For every subsequent boot or a return from a low-power state, the BIOS needs to recalculate the system configuration, specifically, the channel delay. Polling the devices and calculating the channel delay requires a few hundred milliseconds and degrades system boot performance because the operating system needs to wait for the BIOS to complete the re-levelization process before it can begin or resume execution.

Present methods of storing device information include utilizing an electrically erasable programmable read-only memory (EEPROM). The EEPROM is a non-volatile memory because it retains the contents when the power is turned off. The device information is stored in the EEPROM via a serial or parallel interface between it and the processor or chipset to which it is attached. However, the device information is specific to the particular device and lacks any system configuration information.

### BRIEF DESCRIPTION OF THE SEVERAL VIEWS OF THE DRAWINGS

The present invention is illustrated by way of example and not limitation in the following figures. Like references indicate similar elements, in which:

FIG. 1 illustrates a system utilized by an embodiment of the present invention.

FIG. 2 illustrates a flowchart utilized by an embodiment of the present invention.

### DETAILED DESCRIPTION OF THE INVENTION

A software, method and a system for storing initialization data for a basic input and output system are described. In the following description, for purposes of explanation, numerous details are set forth in order to provide a thorough understanding of the present invention. However, it will be apparent to one skilled in the art that these specific details are not required in order to practice the present invention.

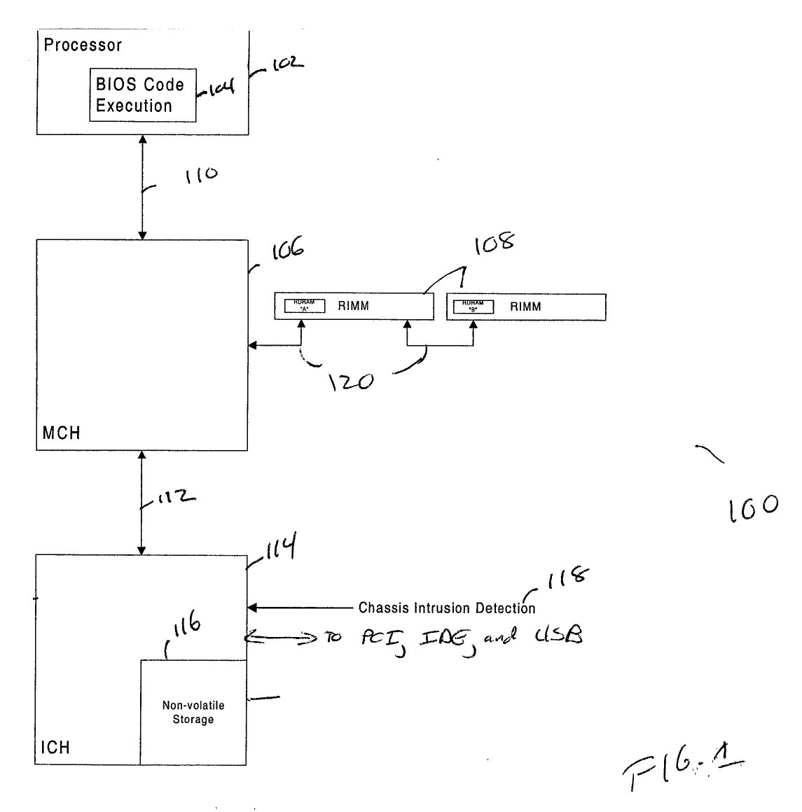

FIG. 1 illustrates a system 100 utilized by an embodiment of the present invention. The system 100 comprises a processor 102 coupled to a memory controller hub (MCH) 106 and an input/output controller hub (ICH) 114. The MCH is connected to a plurality of inline memory modules 108. In one embodiment, the inline memory modules are Rambus™ inline memory modules (RIMM). The RIMM comprises a plurality of RDRAM devices. The MCH has the capability of interfacing with the processor 102, the ICH 114 and the inline memory modules 108.

The processor 102 comprises a BIOS code execution module 104 and issues requests to communicate with the MCH 106 via an interconnect 110. The requests are received by the MCH and forwarded to the RIMM 108 via a plurality of channels 120 or to the ICH 114 via a Hub Interface 112. The ICH comprises a non-volatile memory 116. The ICH receives a Chassis Intrusion Detection signal 118 from the system or board design. In one embodiment, the system board asserts the Chassis Intrusion Detection signal 118 when the system cover has been opened or when power has been removed from the system.

The MCH 106 receives requests from the processor 102 via the interconnect 110. The MCH provides an interface to an accelerated graphics port (AGP), memory modules 108, and a Hub Interface (112). The AGP allows a graphic controller to directly access memory.

The ICH provides an interface to a peripheral component interconnect (PCI), integrated drive electronics (IDE) controller, and a universal serial bus (USB). The PCI is a local bus standard developed by Intel™ and supports a 32 bit or 64 bit bus. The IDE is an interface for mass storage devices in which the controller is integrated into the disk or CD-ROM drive. The USB is an external bus standard and allows a single USB port to connect up to 127 peripheral devices such as modems and keyboards. The ICH comprises the non-volatile memory 116 to store the timing values associated with the time domain and channel delay. If the system 100 is re-booted or returns from a low-power state, the BIOS code execution module 104 retrieves the timing values from the non-volatile memory 116. Therefore, storing the timing values in the trio non-volatile memory eliminates the need for a repeating the re-levelization process for a system boot or a return from a low-power state and saves several hundred milliseconds of system boot time because the non-volatile memory retains the timing values despite the loss of power.

The number of bits required for the timing values for the re-levelization process depends on the method used for encoding the time domain or channel delay information. In one embodiment, the time domain is stored for each RDRAM device. Three bits are required to identify a device's channel position because five possible bus time domains may be encoded in 3 bits. Also, each channel 120 is capable of supporting thirty-two RDRAM devices. Thus, thirty-two devices multiplied by three bits requires ninety six bits (or twelve bytes) to store the timing values generated by the levelization process. In a second embodiment, the timing values are stored for the time domain breakpoints. A breakpoint separates the time domains. Typically, five time domains are utilized. Thus, there are four time domain breakpoints for five time domains. Also, each channel is capable of supporting thirty two RDRAM devices. Thus, twenty bits are required to store the breakpoint timing values, five bits to represent the 32 RDRAM devices multiplied by four bits for the time domain breakpoints.

In one embodiment, the Chassis Intrusion Detection signal 118 is active if the inline memory module configuration has changed or lacks configuration status from the last system boot or a return from the low-power state. A change in inline memory module configuration could consist of a different order of the inline memory modules, or an inline memory module has been removed or added, or any change affecting the distance between the inline memory modules and the MCH 106 or processor 102. Therefore, a re-levelization process is needed if the Chassis Intrusion Detection signal 118 is active because the timing values stored in the non-volatile memory 116 are invalid. Also, a re-levelization process is needed if all power had been removed to the system 100 because the DRAM arrangement cannot be determined to be the same as it was at the time of the last boot.

Those skilled in the art will further appreciate utilizing various embodiments of different locations for the non-volatile memory 116. For example, the processor 102 or MCH 106 could contain the non-volatile memory 116. In another embodiment, the processor 102, MCH 106 and the ICH 114 all contain non-volatile memory 116.

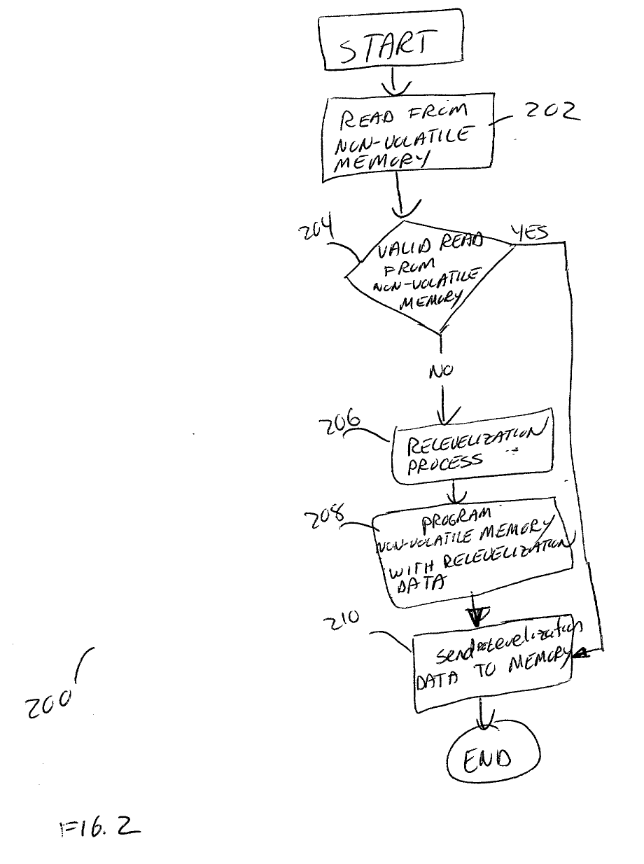

FIG. 2 illustrates a flowchart 200 utilized by an embodiment of the present invention. In one embodiment, the flowchart 200 illustrates a software procedure for the BIOS memory configuration. The flowchart utilizes various hardware modules discussed with reference to FIG. 1. A first block 202 instructs the BIOS code execution to read the timing values from the non-volatile memory 116. Next, a decision block 204 determines if the timing values in the non-volatile memory are valid. The timing values are valid unless the Chassis Intrusion Detection signal 118 is active, a logic 1, because the memory configuration had changed. Therefore, if the timing values are valid the flowchart 200 proceeds to a block 210 and the stored timing values from the non-volatile memory 116 are forwarded to the memory devices in the inline memory modules 108. Otherwise, a re-levelization process is needed and the flowchart 200 proceeds to a block 206. The re-levelization process consists of a levelization in block 206 and programming the non-volatile memory 116 with the timing values from the levelization in block 208.

While the invention has been described with reference to specific modes and embodiments, for ease of explanation and understanding, those skilled in the art will appreciate that the invention is not necessarily limited to the particular features shown herein, and that the invention may be practiced in a variety of ways that fall under the scope and spirit of this disclosure. The invention is, therefore, to be afforded the fullest allowable scope of the claims that follow.

1. An article comprising:
a storage medium having a plurality of machine readable instructions, wherein when the instructions are executed by a processor, the instructions provide to:
read a first set of data from a first memory, the first set of data represents a first memory configuration of a second memory to the computer system; and
transmit the first set of data from the first memory to the second memory in response to a signal.

2. The article of claim 1 further comprising:
replace the first set of data with a second set of data in the first memory for a second memory configuration.

3. The article of claim 1 wherein the first set of data and the second set of data are a time domain and a channel delay.

4. The article of claim 1 wherein the first set of data and the second set of data are a time domain breakpoint and a channel delay.

5. The article of claim 1 wherein the first memory is a non-volatile memory and the second memory is a volatile memory.

6. The article of claim 1 wherein the signal is set when the computer system is initialized to a power up state or the computer system returns from a low power state.

7. A system comprising:
a processor;
a memory control unit coupled to the processor:
a plurality of memory modules comprising a plurality of memory devices coupled to the memory control unit;
a non-volatile memory to store a set of data to represent a configuration of the plurality of memory devices.

8. The system of claim 7 further comprising the non-volatile memory to transmit the set of data from the non-volatile memory to the plurality of memory devices in response to a signal.

9. The system of claim 7 wherein the memory modules are Rambus inline memory modules and the memory devices are RDRAMs.

10. The system of claim 7 wherein the set of data is a time domain and a channel delay for the configuration of the plurality of memory devices for the system.

11. The system of claim 7 wherein the set of data is a time domain breakpoint and a channel delay for the configuration of the plurality of memory devices for the system.

12. The system of claim 8 wherein the signal is set if the configuration of the plurality of the memory devices has changed since the last system initialization or a return from a power down state.

13. A method comprising:
storing the first set of data in a non-volatile memory for a first memory configuration in a system;
comparing a first memory configuration to a second memory configuration after initializing the system; and
transmitting the first set of data from the non-volatile memory to a volatile memory if the first memory configuration is equivalent to the second memory configuration, and storing a second set of data in a non-volatile memory if the first memory configuration is not equivalent to the second memory configuration.

14. The method of claim 13 wherein the first set of data and the second set of data comprises a time domain and channel delay for the volatile memory.

15. The method of claim 13 wherein the first set of data and the second set of data comprises a time domain breakpoint and channel delay for the volatile memory.

16. The method of claim 13 wherein the first memory configuration and second memory configuration are equivalent if the volatile memory has not been physically changed, added to or deleted from in either memory configuration.

17. The method of claim 13 wherein the first memory configuration and second memory configuration are not equivalent if the volatile memory has been physically changed, added to or deleted from in either memory configuration.
